(19) United States
(12) Patent Application Publication
(10) Pub. No.: US 2017/0271706 A1
(43) Pub. Date: Sep. 21, 2017

(54) ELECTROCHEMICAL DEVICE FOR STORING ELECTRICAL ENERGY AND PRODUCING HYDROGEN, AND METHOD FOR PRODUCING HYDROGEN

(71) Applicant: JOMI LEMAN, Fessy (FR)

(72) Inventors: Michel JEHAN, Fessy (FR); Jean-Paul BRIFFOD, Lucinges (FR)

(73) Assignee: JOMI LEMAN, Fessy (FR)

(21) Appl. No.: 15/505,385

(22) PCT Filed: Aug. 17, 2015
(86) PCT No.: PCT/FR2015/052215

§ 371 Date: Feb. 21, 2017

(30) Foreign Application Priority Data
Aug. 19, 2014 (FR) 1457875

(51) Int. Cl. H01M 8/18; H01M 8/04276; H01M 4/04

(52) U.S. Cl. CPC H01M 8/188; H01M 4/0452; H01M 8/04276

(57) ABSTRACT

An electrochemical device, configured for electric power storage, including: a reactor, the wall of the reactor being configured to form a first electrode, the reactor being provided with an electrolyte inlet and an electrolyte outlet, a central electrode arranged in the centre of the reactor, additional electrodes Eₓ, with x an integer ranging from 1 to n, the additional electrodes Eₓ being tubular and arranged around the central electrode.

### FIELD OF THE INVENTION

The invention relates to an electrochemical device for electric power storage and for hydrogen production and to a hydrogen production method.

### STATE OF THE ART

The stakes involved in bulk storage of electric power are considerable. It is in fact essential to have storage units able to operate over a very wide power and capacity range while at the same time privileging reduced volume aspects.

One promising way for storing such energies is the electrochemical channel. At the present time, the most efficient and most dependable electrochemical technology is that of electrolysis of non-ferrous metals in an aqueous medium, and more particularly electrolysis of metals which have a high energy content such as zinc or manganese.

The technology is moreover simple and inexpensive: it would therefore be advantageous to be able to make such an electrolysis operate in reversible manner.

Application WO 2011/015723 describes a simultaneous electric power and hydrogen cogeneration method by totally electrochemical means. The method comprises an electricity storage phase by electrolysis of a solution of an electrolyzable metal and formation of an electrolyzable metal-hydrogen battery, and an electricity recovery and hydrogen generation phase by operation of said battery.

However, in such devices, the volumes of the reactors are very large in order to be able to provide a large quantity of electric power.

Furthermore, for high-power applications, the metallic deposits are often inhomogeneous, which reduces the electrochemical performances of the devices and even causes short-circuiting of the electrodes by formation of metallic dendrites.

### OBJECT OF THE INVENTION

The object of the invention is to remedy the shortcomings of the prior art, and in particular to propose a device enabling a large quantity of electric power to be stored.

This object tends to be achieved by the appended claims.

### BRIEF DESCRIPTION OF THE DRAWINGS

Other advantages and features will become more clearly apparent from the following description of particular embodiments of the invention given for non-restrictive example purposes only and represented in the appended drawings, in which:

FIG. 1 represents a schematic view, in cross-section, of a reactor of an electrochemical device according to an embodiment of the invention,

FIG. 2 schematically represents, in top view, a stack of electrodes of a reactor of an electrochemical device according to the invention,

FIG. 3 represents a schematic view, in cross-section, of a reactor of an electrochemical device according to another embodiment of the invention,

FIG. 4 schematically represents, in top view, an electrochemical device comprising several reactors, according to another embodiment of the invention,

FIG. 5 schematically represents an electric coupling of two reactors, according to an embodiment of the invention.

### DESCRIPTION OF A PREFERRED EMBODIMENT OF THE INVENTION

The invention relates to an electrochemical device for storing electric power in direct and reversible manner.

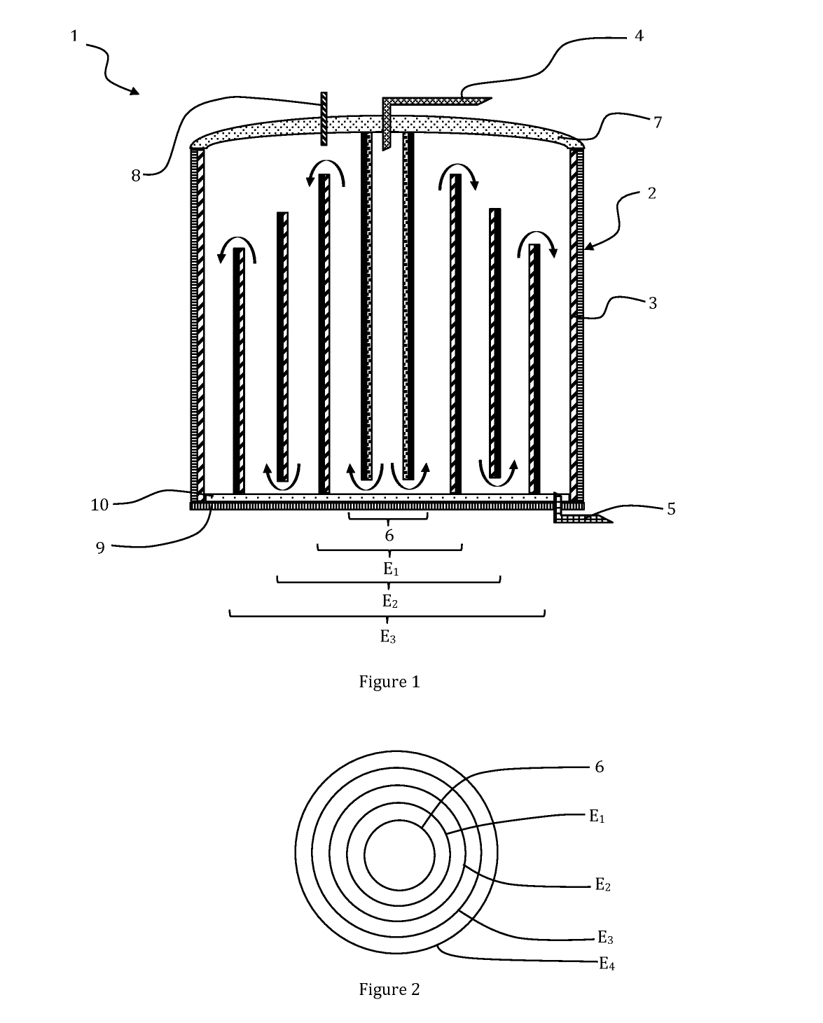

As represented in FIG. 1, the reversible electrochemical device 1, configured for electric power storage and for hydrogen production, comprises:
a reactor 2, the wall of the reactor advantageously forming a first electrode 3,
the reactor 2 being provided with an electrolyte input 4 and an electrolyte output 5,
a central electrode 6 located in the centre of the reactor 2, the central electrode 6 being substantially parallel to the wall of the reactor 2,
additional electrodes Eₓ, with x an integer ranging from 1 to n,
the additional electrodes Eₓ being tubular and arranged around the central electrode 6.

The central electrode 6 is preferentially tubular. What is meant by tubular is that the electrode has a closed cross-section preferably of cylindrical or ovoid shape.

Advantageously, the electrode is hollow so as to allow passage of the electrolyte.

In one operating mode, the central electrode 6 forms the anode of the electrochemical device. The central electrode 6 is then connected to a positive terminal of a DC electric power supply.

The central electrode 6 is advantageously supported by the cover 7 of the reactor to facilitate fabrication of a device that is robust and simple to implement.

In a particular case, the cover 7 is electrically conductive and it is then advantageous to electrically connect the cover 7 with the positive terminal of the DC power supply to polarise the central electrode which bathes in the electrolyte.

The central electrode 6 is for example formed by an electrically conductive tube. Preferentially, the tube is a metallic tube.

The metallic tube can be covered by a coating on its outer diameter to enhance the electrochemical reactions and its resistance to chemical and gas attacks.

The central electrode 6 is advantageously made from a material that is a unable to be attacked by oxygen in an acid medium. It is for example covered by titanium nitride on its surface, made from steel covered by an electrically conductive ceramic. This conductive ceramic is non oxide.

As represented in FIGS. 1 and 2, the additional electrodes Eₓ are advantageously tubular. They surround the central electrode 6.

They are advantageously of increasing and symmetrical cross-sections with respect to the central electrode 6.

Preferentially, the additional electrodes Eₓ are concentric. What is meant by concentric is that the electrodes are concentric or substantially concentric. Advantageously, the centre of the additional electrodes Eₓ corresponds to the centre of the central electrode 6.

The additional electrodes Eₓ are nested in one another like “Russian dolls”. Advantageously, the additional electrodes and the central electrode 6 are in the form of a tube.

Electrode E₁ is the closest additional electrode to the central electrode 6. It is the proximal electrode with respect to the central electrode 6.

Electrode Eₙ is the farthest additional electrode from the central electrode 6. It is the distal electrode with respect to the central electrode 6.

FIG. 1 represents for example a reactor comprising three concentric additional electrodes E₁, E₂ and E₃, arranged around the central electrode. The distal electrode is electrode E₃.

FIG. 2 represents, in top view, additional electrodes Eₓ with x=4. The distal electrode is electrode E₄.

The electrochemical potential of the additional electrodes Eₓ is said to be floating i.e. the total potential difference provided by the electric generator between electrode 6 and electrode 3 supported by the tank is distributed naturally between each of the electrodes Ex.

In preferential manner, the electrodes Eₓ have the same morphology, i.e. the shape of one of the electrodes is modified by scaling to form the other electrodes. This configuration makes it possible to have a fixed difference between two electrodes and therefore a better distribution of the potentials and of the chemical reactions.

Advantageously, a tubular configuration enables deformation of the electrodes to be limited during electrolysis. It is thus possible to substantially reduce the thickness of the electrodes compared with electrodes configured in flat structures which deform very greatly. The use of concentric tubular electrodes rather than flat electrodes makes it possible to obtain a more compact stack with an improved exchange surface.

This electrode assembly enables large reaction surfaces to be obtained in an extremely small space. The volume of the reactor 2 can be considerably reduced.

Such devices enable larger quantities of energy to be stored than a device with flat electrodes, for the same reactor volume.

The number of additional electrodes depends on the required electric power.

The total number of electrodes having floating electric potential supported in the tank is an odd number.

Additional electrodes Eₓ present different heights.

Preferentially, the additional electrodes Eₓ present a height Hₓ, the height Hₓ of the electrodes being decreasing from the proximal electrode E₁ to the distal electrode Eₙ.

The height of each of the electrodes is defined by the formula:

Hₓ=D₀·H₁/(D₀+2·P·n)

with

Hₓ the height of electrode x,

D₀ the diameter of the central electrode in mm,

H₁ the height of the proximal electrode in mm,

P the distance between two successive electrodes, the pitch between two successive electrodes,

n the number of additional electrodes.

Advantageously, the active reaction surface remains homogeneous from one pair to the other, from the centre of the reactor to the outer body, the surface varying in the ratio of the perimeters of the concentric elements the height of which is calculated with the object of achieving a current isodensity.

The pitch P, the distance between two successive electrodes, is advantageously comprised between 0.2 cm and 4 cm. Preferentially, the distance between the electrodes is comprised between 0.5 cm and 1.5 cm, which enables ohmic losses to be considerably reduced.

Preferentially, the architecture of the reactor is configured so that the additional electrodes Eₓ are bipolar. What is meant by bipolar is that the electrodes can act both as anode and as cathode. The bipolar electrode presents two surfaces: an anodic surface and a cathodic surface.

During the electrodeposition step, the metal is deposited on the cathodic surface and the native oxygen forms on the anodic surface.

These particular electrodes are advantageously designed from materials suitable for these electrochemical conditions, and in particular for bipolarity. The electrodes are for example made from lead, nickel, or titanium with advantageously for each of said materials electrically conductive coatings such as non-oxide ceramics.

The electrodes can also be mixed bipolar electrodes made from lead oxide and lead, or from lead alloy.

Preferentially, electric power storage is performed on mixed bipolar electrodes made from lead oxide and lead, thus forming a battery, in a cylindrical and concentric configuration. These electrodes enable energy to be stored in a very small volume having a large exchange surface.

The bipolar electrodes enable total polarity reversal and operation as counter-electrodes in the chemical attack phase when the polarities are reversed when the reactor is used as a hydrogen generator. The hydrogen is extracted under pressure through the cover via the gas outlet or collector 8.

Preferentially, at least one of the surfaces of the additional electrodes is coated with conductive ceramics. The ceramics are advantageously non-oxides. They can be formed by silicon carbide (SiC), titanium carbide (TiC), silicon nitride (Si₃N₄), titanium nitride (TiN), etc.

Advantageously, the set of bipolar additional electrodes Eₓ therefore forms a compact stack of electrochemical surfaces facing one another, one surface of which acts as anode and the other surface as cathode.

The additional electrodes Eₓ are electrically insulated from one another. They are also electrically insulated from the wall of the reactor 2 which forms the cathode, and from the central electrode 6 which forms the anode.

The potential between each electrode, called “floating potential”, balances out in natural manner in the electrolyte bath flowing between the electrodes. This potential depends on the potential difference applied between the tank and the cover of the reactor, and also on the number of additional electrodes Eₓ.

The reactor 2 is for example a tank. The tank is made from an electrically conductive material. The reactor is advantageously configured so that the electrolyte flows from the centre of the reactor to its periphery following the circuit imposed by the electrodes Eₓ. In this way, it is easier to control the reactions within the reactor.

Advantageously, the material forming the tank, and the thickness of the material, will be chosen by the person skilled in the art so as to present mechanical properties enabling it to withstand the hydrogen pressure and resist corrosion.

The tank is for example made from aluminium. It is advantageously cathodically protected.

Advantageously, the centre of the tank corresponds to the centre of the central electrode 6 and also to the centre of the additional electrodes Eₓ. All these elements are concentric.

The reactor 2 is preferentially a closed reactor in which the electrolyte flows. The reactor is formed by a wall, a bottom and a cover. The wall is a side wall. It is preferentially circular.

The reactor wall advantageously forms the first electrode 3. According to one embodiment, the first electrode could be formed by another tubular electrode arranged between the additional electrode Eₙ and the reactor wall.

The reactor wall advantageously forms a first electrode. It forms the cathode of the device. It is connected to the negative pole of the DC power supply.

The reactor is closed at its top part by a cover 7.

Advantageously, the cover 7 is frustum-shaped in order to withstand the gas pressure generated inside the reactor.

The cover 7 comprises for example a clamp at its periphery and a seal serving the purpose of maintaining the pressure inside the tank and at the same time acting as electric insulator between the tank at negative potential and the cover 7 at the positive potential of the external electric generator.

The cover 7 acts as mechanical support for the central electrode 6 which acts as anode. The cover 7 is electrically connected to the anode and is at the potential of the positive terminal of the external power supply.

The gases given off during the operating phases are collected via the top part of the reactor 2 which is provided with a gas outlet 8.

Flowrate sensors of the liquids and gases and sensors measuring the electric conditions of the device during the different steps of the method are integrated in the electrochemical device. The device can further comprise a calculator enabling the liquid flow rate to be regulated according to the gas flowrate.

According to a preferred embodiment, the bottom 9 of the reactor is electrically insulating. For example, and as represented in FIG. 1, an electrically insulating plate 10 is deposited on the bottom 9 of the reactor 2 and prevents electric contact between the bottom 9 of the reactor 2 and the electrodes 3.

Preferably, the electrically insulating plate 10 performs electric insulation of the electrodes inside the reactor and also acts as mechanical support. The concentricity of the electrodes is achieved by their engagement in circular grooves machined in this electric insulator. The grooves are machined to define the pitch P.

According to a preferential embodiment, the electrolyte inlet 4 of the reactor is located in the top part of the central electrode, on the apex of the central electrode 6.

The electrolyte is for example propelled through the cover into the central electrode by a volumetric pump, which enables the flowrate and pressure of the electrolyte to be regulated.

The electrolyte outlet 5 is located in the bottom part of the reactor 2, between the electrode Eₙ and the reactor wall.

In the case where the bottom 9 of the tank is electrically insulating, the central electrode 6 and additional electrodes Eₓ, with x an even integer, are separated from the bottom 9 of the reactor 2 by an empty space. Additional electrodes Eₓ, with x an odd integer, are in contact with the bottom 9 of the reactor 2.

In the case where the bottom 9 of the tank is covered by an electrically insulating plate 10, the additional electrodes Eₓ with x an even integer are separated from the electrically insulating plate 10 by an empty space, and the additional electrodes Eₓ with x an odd integer are in contact with the bottom 9 of the reactor 2, the electrically insulating plate 10.

A flow path of the electrolyte is thus formed, the path running from the electrolyte inlet 4 to the electrolyte outlet 5, passing alternately at the level of the top part or at the level of the bottom part of the additional electrodes Eₓ.

The path of the electrolyte is schematically represented by arrows in FIG. 1.

The electrolyte flows, in a first stage, in the tube of the central electrode 6, and then flows up along the additional electrode E₁. By overflow, it passes over the additional electrode E₁ to reach the second reaction interface.

The electrolyte then passes through the calibrated passage holes at the foot of the electrode E₂. The electrolyte thus flows in symmetrical manner from the central electrode to the electrode Eₙ, where after a last overflow, it is evacuated from the tank via an aperture forming the electrolyte outlet 5, located at the foot of the tank.

In this embodiment, flow of the electrolyte is natural and gravitational.

This architecture enables an excellent circulation of the electrolyte fluxes to be obtained, its permanent renewal in front of each electrode using the central electrode 6 as inlet means of the electrolyte into the reactor via the centre of the latter.

The decreasing height of the electrodes from the proximal electrode E₁, closest to the central electrode, to the distal electrode Eₙ, farthest from the central electrode, ensures overflow of the electrolyte and makes it possible to control the current densities of the pairs of electrodes which have to be constant.

The circulation of the inter-electrode fluids is simplified as it is directed symmetrically from the centre of the reactor to the outside of the reactor by a single supply.

Such a totally symmetric geometry enables a pertinent circulation of the electric currents to be delivered from one electrode to the other and eliminates leakage currents.

Control of the circulation of the electric currents, associated with a reduction of the turbulences, results in a better homogeneity of the metallic deposits.

Advantageously, the heat losses are reduced and well distributed.

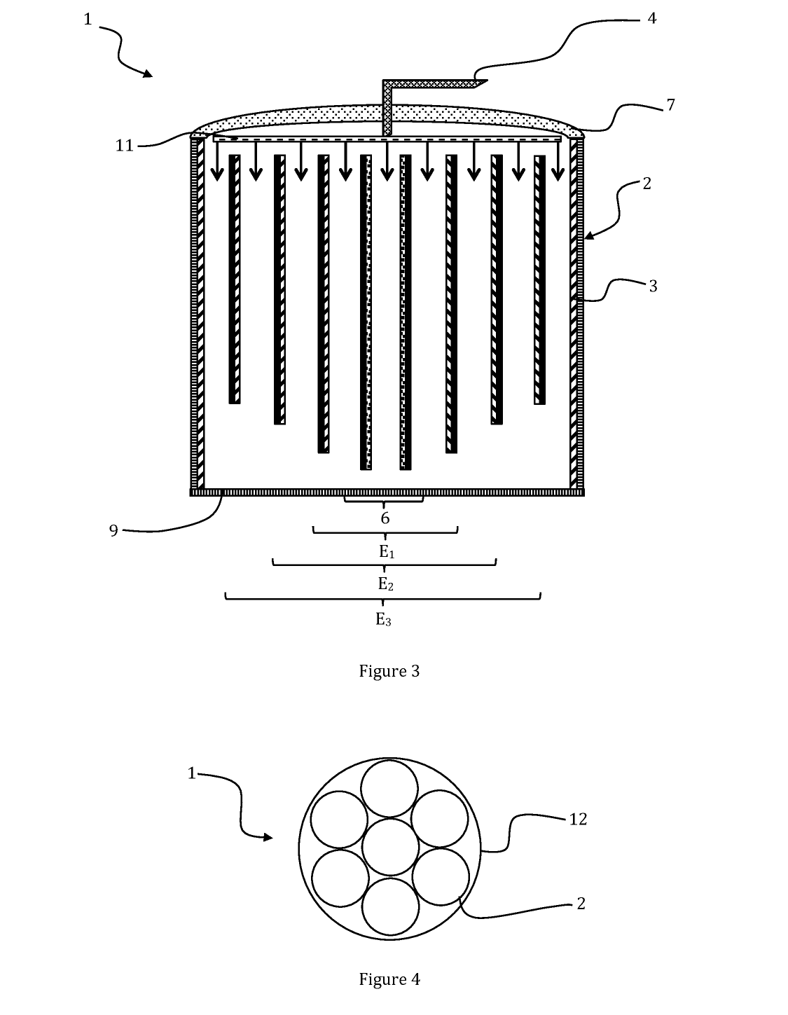

According to another preferred embodiment, and as represented in FIG. 3, the top level of the additional electrodes Eₓ is at the same height.

The level of the electrodes can be equalised by means of shims placed at the foot of each electrode. The shims enable a space to be maintained between the bottom of the reactor and the additional electrodes.

The securing system can also be arranged at the level of the top part of the electrodes.

The shims and securing system, not represented in FIG. 3, are electrically insulating.

This configuration is particularly used when the reactor 2 comprises lead electrodes, in the case of direct electricity storage, and without release of gas (reactor working at atmospheric pressure).

Advantageously, in this embodiment, the bottom 9 of the reactor does not need to be insulating.

The electrolyte inlet 4 is arranged in the top part of the reactor 2, and the electrolyte outlet 5 is arranged in the bottom part of the reactor 2. The electrolyte outlet 5 can be formed by one or more apertures located at the level of the bottom 9 of the reactor 2.

Only the electrolyte inlet 4 to the tank has been represented.

The electrochemical device 1 comprises an injector 11 connected to the electrolyte inlet and configured to inject the electrolyte between each additional electrode. The electrolyte then flows in parallel direction between each electrode. The flow of the electrolyte is represented by arrows in FIG. 3.

The electrolyte level rises gradually in the reactor, progressively placing the electrodes of the different pairs in contact with one another via said electrolyte.

Preferentially, and as represented in FIG. 4, the reactor 2 is arranged in a cooling tank 12 to enable the heat accumulated in the body of the tank 2 to be removed thereby preventing problems of overheating of the electrochemical device.

Advantageously, in case of a hydrogen leak for example, the hydrogen spreads into the water of the cooling tank where it is advantageously immediately dissolved.

The electrochemical device, with its assembly of bipolar electrodes, presents an ideal distribution of the electric currents flowing from one bipolar electrode to another electrode, in operation, while at the same time ensuring a precise and controlled gravitational flow of the electrolyte fluxes of the chemical solution containing the metal to be deposited.

The assembly of the electrodes inside the electrochemical device makes it possible to obtain a better compactness of the active surfaces, electrochemical compression of the gas produced, operation at temperatures chosen at ambient temperature with greatly improved heat exchange coefficients and partial and direct recovery of the electrical energies induced in the chemical dissolution reactions.

The morphology of the electrodes, the original electric connections via the body of the reactor with complementary internal stacking of bipolar electrodes having a floating electric potential between the main cathode, the body of the reactor and the central anode supported by the cover of the reactor enables a very compact and concentric assembly to be obtained presenting a large active surface density in a small volume.

The reversible electric energy storage or hydrogen production method comprises the following successive steps:
providing an electrochemical device 1 as described in the foregoing,
inlet of an electrolyte into the electrochemical device 1, the electrolyte containing metallic ions,
electrically connecting the first electrode 3 to the negative terminal of an electric power supply and the central electrode 6 to the positive terminal of an electric power supply,
providing electric power to reduce the metallic ions on the electrodes so as to form an electrolyzable metal-dihydrogen battery.

The electrolyte contains metallic ions, which can for example be zinc, manganese or nickel, or cadmium.

The first electrochemical step, i.e. energy storage, is performed by electrodeposition of the metal in solution on the electrodes of the electrochemical device 1.

Electric power storage takes place in the form of a metallic deposit.

When electrodeposition of the metal is performed, electric power is consumed. The electrolyte, also called liquor, can be added continuously with water containing sulphates of a metal.

During the electrodeposition phase of the metal on the cathodes, i.e. on the wall of the reactor and on the cathodic surfaces of the bipolar electrodes nesting in one another, oxygen is released at the anodes. The oxygen is extracted from the reactor via an aperture arranged in the top part of the cover. Advantageously, the oxygen is removed continuously.

When electrodeposition of the metal is performed, the metal content of the electrolyte changes, decreasing progressively.

For example, in the case of a zinc sulphate electrolyte, the mass concentration of the metal electrolyte decreases from 150 g/L, at the beginning of the electrodeposition phase, down to 50 g/L, at the end of the electrodeposition phase. At the same time, the electrolyte progressively acidifies. Preferentially, at the beginning of the electrodeposition phase, the mass metal concentration is comprised between 100 g/L and 200 g/L. Even more preferentially, it is about 150 g/L.

Preferentially, the device 1 comprises an electrolyte tank connected to the electrolyte inlet 4 and to the electrolyte outlet 5 of the reactor 2 so as to form a closed circuit. The electrolyte, used to form the electrolyzable metal-dihydrogen battery, is reused for the operating phase of said battery.

In the electrodeposition phase, the electrolyte is stored progressively in the storage tank. The tank then acts as supply reserve for the electric power production phase.

After the electrodeposition phase, the electrolyte is advantageously removed from the reactor 2. By this draining of the electrolyte, there is no longer any possible current flow and the circuit is open.

The metal deposition performed is stable when the electrolyte is drained from the tank and is no longer in contact with said deposited metal. The deposition is conserved for a very long time without oxidising, intrinsically conserving the electric power it consumed during its electrodeposition.

After formation of the electrolyzable metal-dihydrogen battery, the method comprises an operating phase of said battery, the operating phase comprising dissolution of the previously deposited metal so as to produce electric power and dihydrogen.

The electrolyte of the electrolyzable metal-dihydrogen battery is reused for the operating phase of said battery.

According to a preferred embodiment, after formation of the electrolyzable metal-dihydrogen battery, the electrolyte is drained out of the reactor 2. This enables the electrodes to be conserved for long periods.

Advantageously, the electrolyte is always drained from the reactor in the intermediate phases and in the down phase of the equipment, and the equipment is powered-off.

The electrolyte is reinserted in the operating phase of said battery for production of dihydrogen.

In the operating phase of the electrolyzable metal-dihydrogen battery, i.e. when dissolution of the metal takes place, the electric power is recovered. The first electrode 3 and central electrode 6 are connected to an energy recovery system.

The reactor supplies hydrogen, under pressure. The pressure is for example about 80 bars.

Dihydrogen, formed in the operating phase of the electrolyzable metal-dihydrogen battery, is extracted under pressure via the gas outlet 8.

When controlled dissolution of said metal deposited on the electrodes in the reactor used for deposition takes place, the electrolyte advantageously flows in controlled manner between the electrodes. The electrolyte flows by flowrate-controlled gravitational overflow. The electrolyte was formed, in the previous operation, flowing in a closed loop and having an acid content which has changed and will no longer have the same stoichiometry compared with the initial sulphate content, this dissolution producing an hydrogen release on the electrically connected counter-electrode, the reactor having become an electric generator by battery effect.

Advantageously, the electrolyte is inlet to the reactor from the storage tank at a corresponding pressure by a pump.

The electrochemical device can comprise a valve that is specifically calibrated, or controlled by an external controller, to the required pressure. The valve regulates the pressure on the outlet 5 of the tank.

At the beginning of the chemical attack, the acid content is situated between 50 g/L and 200 g/L.

As the chemical attack of the metal progresses, the metal is replaced in solution in the electrolyte. In the case of zinc, the zinc sulphate solution is regenerated for a future new use, the electrolyte flowing in a closed loop.

According to the chosen configuration, controlled circulation of the electrolyte enables either direct storage of the electric power or direct transformation of the electric power into hydrogen under pressure, in a second electrochemical step. The reactor behaves as a cathode, in the storage phase, and it also acts as pressurised gas generator in the electric power and dihydrogen production phase.

According to a preferred embodiment, several reactors are electrically connected to one another. The reactors can be connected in series and in parallel.

Preferentially, the device comprises at least a second reactor, the two reactors being mounted in series, the reactors being electrically connected.

The two reactors are in fluid communication: the second reactor is arranged between the first reactor and the electrolyte tank, the electrolyte outlet of the first reactor being connected to the electrolyte inlet of the second reactor and the electrolyte outlet of the second reactor being connected to the electrolyte tank.

For example, and as represented in FIG. 4, seven reactors have been assembled in series in a cooling tank 12.

The reactors are electrically symmetrical. Each reactor comprises 19 internal electrodes, i.e. 20 electrochemical pairs. Each reactor can supply 60 volts.

The electrodes are mixed lead and titanium electrodes coated with complex nitrides.

Each set of electrodes presents an active surface comprised between 20 and 25 m² for an external reactor diameter of less than 1 m. Each reactor has a current of 500 amps passing through it.

During the tests performed in the presence of zinc sulphate, and in the electrodeposition step, between 15 kg and 20 kg of zinc were deposited per reactor and per powered-on hour.

In the second step, in the dihydrogen production configuration, a flowrate of 1000 to 1500 Nm³/h (standing for normo-cubic metres per hour) of hydrogen was obtained.

The cooling tank 12 enabled seven reactors to be cooled to an operating temperature comprised between 30° C. and 70° C.

Advantageously, the electric connections for operation of the electrochemical device are very simple to fit.

The reactor is supplied by a DC generator, in the energy storage phase, and the reactor itself behaves as a controlled generator when it generates hydrogen.

The central anode is fixed firmly via its electric connection to the cover, whereas the reactor body forming the cathode is connected to the negative terminal of the generator when electrodeposition of the metal takes place.

During the chemical attack, the reactor acts as an electricity generator. It is then electrically connected to one or more energy recovery systems.

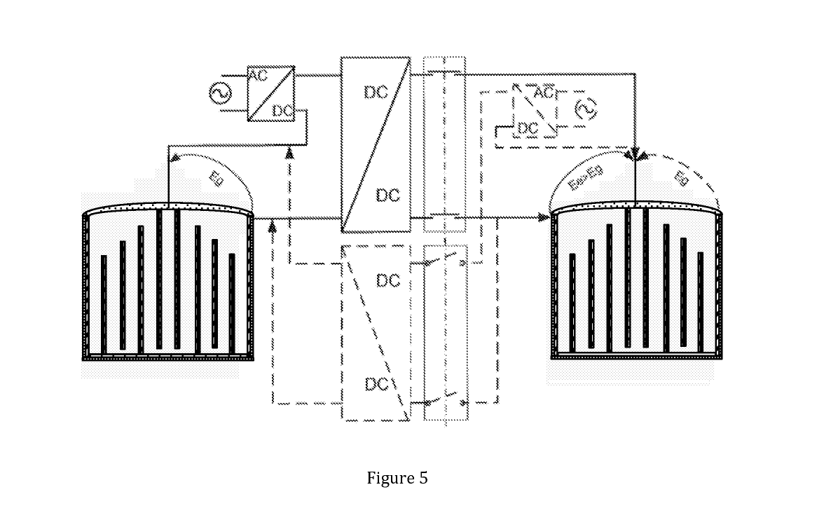

FIG. 5 represents an electrochemical device comprising two electrically-coupled reactors.

This configuration enables the electricity generator effect to be used by using the energy produced in the reactor in the metal electrodeposition phase, by means of connections with DC-DC BOOST converters. The connections enable the direction of the electric currents to be reversed.

The reactors are electric power receivers during a given period. This is the case of the electrodeposition phase. They then produce oxygen. Such an external DC supply provides the energy necessary for electrodeposition. This direct current can also be pulsed.

The reactors are then electric power generators in the phase of chemical attack of the deposited metal. They then generate an electric current by battery effect. The current is used through the connection of the reversible electronic converter.

The method enables available electric power to be stored, for example during off-peak hours, and the stored electric power to be recovered with a high efficiency, for example during peak hours, electric power recovery being accompanied by hydrogen production.

1-20. (canceled)

21. Electrochemical device configured for electric power storage and hydrogen production comprising:
a first reactor having a wall being configured to form a first electrode, the first reactor being provided with an electrolyte inlet and an electrolyte outlet,
a central electrode located in a centre of the first reactor,
a plurality of additional electrodes Eₓ, with x an integer ranging from 1 to n, the additional electrodes Eₓ being tubular and arranged around the central electrode.

22. Electrochemical device according to claim 21, wherein the additional electrodes Eₓ are provided with an anodic surface and a cathodic surface.

23. Electrochemical device according to claim 22, wherein at least one of the anodic surface and cathodic surface of the additional electrodes Eₓ is coated with conductive ceramics.

24. Electrochemical device according to claim 21, wherein the additional electrodes Eₓ present a height Hₓ, the height Hₓ of the additional electrodes Eₓ being decreasing from the additional electrode E₁ proximal to the central electrode to the additional electrode Eₙ proximal to the wall of the first reactor, the height being measured along a direction perpendicular to a bottom of the first reactor.

25. Electrochemical device according to claim 24, wherein the height Hₓ of the additional electrodes Eₓ is defined by Hₓ=D₀·H₁/(D₀+2·P·n)
with
Hₓ the height of the additional electrodes Eₓ
D₀ the diameter of the central electrode in mm
H₁ the height of the proximal electrode in mm
P the distance between two successive electrodes
n the number of additional electrodes Eₓ.

26. Electrochemical device according to claim 21, wherein a bottom of the first reactor is electrically insulating.

27. Electrochemical device according to claim 21, wherein:
the electrolyte inlet is located in a top part of the central electrode;
the electrolyte outlet is located in a bottom part of the first reactor, between the additional electrode Eₙ and the wall of the first reactor;
the central electrode and the additional electrodes Eₓ with x an even integer are separated from the bottom of the first reactor by a gap;
the additional electrodes Eₓ with x an odd integer are in contact with the bottom of the first reactor;
so as to form a flow path of an electrolyte, the path running from the electrolyte inlet to the electrolyte outlet, passing alternately at the level of a top part of the additional electrodes Eₓ with x an odd integer and at the level of the bottom part of the additional electrodes Eₓ with x an even integer.

28. Electrochemical device according to claim 21, wherein:
the electrolyte inlet is located in a top part of the first reactor;
the electrolyte outlet is located in a bottom part of the first reactor;
the electrochemical device comprises an injector configured to inject an electrolyte between each additional electrode Eₓ, the additional electrodes Eₓ being separated from the bottom of the first reactor by a gap.

29. Electrochemical device according to claim 21, wherein the additional electrodes Eₓ are electrically insulated from one another and wherein the additional electrodes Eₓ are electrically insulated from the first electrode and from the central electrode.

30. Electrochemical device according to claim 21, wherein the first reactor is arranged in a cooling tank.

31. Electrochemical device according to claim 21, comprising an electrolyte tank connected to the electrolyte inlet and to the electrolyte outlet of the first reactor so as to form a closed circuit.

32. Electrochemical device according to claim 21, comprising at least a second reactor, the first and second reactors being mounted in series, the first and second reactors being electrically connected, and wherein the second reactor is located between the first reactor and the electrolyte tank, the electrolyte outlet of the first reactor being connected to an electrolyte inlet of the second reactor, and an electrolyte outlet of the second reactor being connected to the electrolyte tank.

33. Electrochemical device according to claim 21, wherein the first electrode is electrically connected to a negative terminal of an electric power supply and wherein the central electrode is connected to a positive terminal of the electric power supply.

34. Electrochemical device according to claim 21, wherein the first electrode and the central electrode are connected to an energy recovery system.

35. Electric power storage method comprising the following successive steps:
providing an electrochemical device comprising:
a first reactor having a wall being configured to form a first electrode, the first reactor being provided with an electrolyte inlet and an electrolyte outlet;
a central electrode located in a centre of the first reactor;
a plurality of additional electrodes Eₓ, with x an integer ranging from 1 to n, the additional electrodes Eₓ being tubular and arranged around the central electrode;
inlet of an electrolyte into the electrochemical device, the electrolyte containing metallic ions;
electrically connecting the first electrode to a negative terminal of an electric power supply and the central electrode to a positive terminal of the electric power supply;
providing electric power to reduce the metallic ions on the electrodes of the electrochemical device by depositing metal on the electrodes of the electrochemical device so as to form an electrolyzable metal-dihydrogen battery.

36. Method according to claim 35, comprising, after formation of the electrolyzable metal-dihydrogen battery, an operating phase of said electrolyzable metal-dihydrogen battery, the operating phase comprising dissolution of the deposited metal so as to produce electric power and dihydrogen.

37. Method according to claim 36, wherein, when dissolution of the metal takes place, the first electrode and central electrode are connected to an energy recovery system.

38. Method according to claim 36, wherein the dihydrogen, formed in the operating phase of the electrolyzable metal-dihydrogen battery, is extracted under pressure via a gas outlet.

39. Method according to claim 35, wherein the electrolyte, used to form the electrolyzable metal-dihydrogen battery, is reused for the operating phase of said electrolyzable metal-dihydrogen battery.

40. Method according to claim 35, wherein, after formation of the electrolyzable metal-dihydrogen battery, the electrolyte is drained out of the reactor.
